(19) United States
(12) Patent Application Publication
(10) Pub. No.: US 2024/0363876 A1
(43) Pub. Date: Oct. 31, 2024

(54) DEVICE AND METHOD FOR RECIRCULATING ANODE GAS IN AN ANODE CIRCUIT OF A FUEL CELL SYSTEM, AND FUEL CELL SYSTEM

(71) Applicant: Robert Bosch GmbH, Stuttgart (DE)

(72) Inventor: Hans-Christoph Magel, Reutlingen (DE)

(21) Appl. No.: 18/688,472

(22) PCT Filed: Aug. 16, 2022
(86) PCT No.: PCT/EP2022/072858

§ 371 Date: Mar. 1, 2024

(30) Foreign Application Priority Data
Sep. 13, 2021 (DE) 10 2021 210 058.9
Feb. 1, 2022 (DE) 10 2022 201 020.5

(51) Int. Cl. H01M 8/04089; H01M 8/04082; H01M 8/04746

(52) U.S. Cl. CPC H01M 8/04097; H01M 8/04201; H01M 8/04753

(57) ABSTRACT

The invention relates to a device (1) for recirculating anode gas in an anode circuit of a fuel cell system (31) and to a fuel cell system (31) comprising a device (1) according to the invention.

The invention additionally relates to a method for recirculating anode gas in an anode circuit of the fuel cell system (31), in which at least two jet pumps (4, 6) connected in parallel are used and are operated individually or jointly depending on the load.

### BACKGROUND

The invention relates to a device for recirculating anode gas in an anode circuit of a fuel cell system. Further proposed is a method for recirculating anode gas in an anode circuit of the fuel cell system. The device enables the performance of the method according to the invention. In addition, the invention relates to a fuel cell system comprising a device according to the invention.

A fuel cell system comprises at least one fuel cell that can be used to convert a fuel, e.g. hydrogen, and an oxidizing agent, e.g. oxygen, into electrical energy, heat, and water. A fuel cell comprises an anode and a cathode for this purpose. During operation of the fuel cell system, the anode is supplied with the fuel, and the cathode is supplied with the oxidizing agent. Accordingly, the fuel is the anode gas.

Systemically, when supplying the anode with fuel or anode gas, the approach of recirculating the still fuel-rich anode gas exiting the fuel cell and feeding it back to the anode together with fresh fuel has become established. In this case, a jet pump in combination with a further jet pump as a gas conveying unit is often used to cover a recirculation output at different operating states, in particular a high-load operation and a low-load operation. The jet pumps can be operated individually or jointly, depending on the load. The jet pumps are in this case supplied with hydrogen by a separate metering valve per jet pump to ensure a flexible, needs-based metered addition of the anode gas, which is in particular a drive medium.

A device comprising at least two jet pumps connected in parallel is known from DE 10 2007 004 590 A1. For safety reasons, a check valve is typically additionally used in each of the two jet pumps in order to prevent a reverse flow of the conveying quantity through the respective jet pump. The high costs for two separate check valves, which increase the overall costs of the device, are problematic.

### SUMMARY

The present invention is concerned with solving this problem. Proposed in order to solve this problem are the device according to the disclosure and the method according to the disclosure. Further specified is the fuel cell system having the device according to the invention.

Proposed according to the invention are a device and method for recirculating anode gas in an anode circuit of a fuel cell system, and a fuel cell system. The device comprises at least two jet pumps connected in parallel, each of which can be operated operated individually or jointly depending on the load, whereby a drive medium is supplied at least indirectly to the jet pumps, in particular from a tank via a respective metering valve and an incoming flow line.

The device according to the invention is designed such that a first jet pump is fluidically connected at the inflow end or at the outflow end via at least one check valve to a fuel cell, in particular an anode region, whereby a second jet pump without such a check valve, in particular in the flow path, is fluidically connected at the inflow end or at the outflow end to the fuel cell, in particular the anode region. In this way, the advantage can be achieved that an inexpensive design of the device can be brought about as an additional second check valve for the second jet pump can be omitted. In addition, the need for design space is significantly reduced by the elimination of the additional second check valve. Thus, a more compact design of the device can be brought about, thereby requiring less design space in the entire vehicle. Furthermore, the service life of the device can be increased, as the risk of a defective second check valve is completely avoided due to the saving thereof. Furthermore, this embodiment of the device according to the invention can improve the cold start capability of the device and thus the entire fuel cell system, in particular at temperatures below 0° C. at which a high humidity is present in the anode circuit. Freezing of the second check valve in the region of the second jet pump is therefore prevented because the second jet pump is designed without such a second check valve, and/or it is connected to a fuel cell. As a result, the second jet pump can be operated reliably, even at low temperatures, and a start of the fuel cell is possible at any time.

According to a particularly advantageous embodiment of the device, the check valve of the first jet pump is located at the outflow end in the region of a connection line or between the connection line and the first jet pump. In addition or alternatively, the or an additional check valve can be located at the inflow end via a first inlet in the region of a return line or between the return line and the first jet pump. In this way, a reverse flow of the conveying quantity through the first jet pump can be reliably prevented, in particular while the first jet pump is not performing quantity control of the drive medium. In addition, this inventive embodiment of the device can lead to a compact design of the device.

According to one advantageous embodiment of the device, the second jet pump is designed for low-load operation. In this case, the quantity control of a drive medium, in particular in the context of metered addition, is only performed by a second metering valve. In the case of low-load operation, only the second jet pump can therefore be operated by fluidically disconnecting the first jet pump from the supply line by means of the metering valve and also preventing a reverse flow of the conveying quantity through the first jet pump by means of the check valve. The second jet pump features better efficiency than the first jet pump during low-load operation of the fuel cell system due to its size and/or the design of the flow contours. In addition, no friction losses occur due to a flow of the anode gas through the first jet pump. A consistently high recirculation power and/or a high efficiency can be provided thereby.

According to a particularly advantageous embodiment, the first jet pump is designed for high-load operation, and a quantity control of a drive medium, in particular in the context of metered addition, is performed by a first metering valve. In this way, a consistently high recirculation performance can be provided because the jet pumps can be separately controlled. In addition, the efficiency of the fuel cell system can be improved as an optimal feed of the fuel cell can be performed by the first jet pump.

According to a particularly advantageous embodiment of the device, the second jet pump also features at least approximately identical pressure build-up potential as the first jet pump, which is at least nearly zero, in particular due to the geometric design of the second jet pump, even at a low conveying quantity. In this way, by means of this pressure build-up potential, a reverse flow of the conveying quantity of the anode gas through the second jet pump can be prevented. The efficiency of the device and/or the fuel cell system can be improved thereby.

According to one advantageous embodiment of the device, the supply line branches from the first shut-off valve coming in the region of a first node point into a first supply line and a second supply line. In this way, the first and second jet pumps can be connected in parallel. In this case, only the second jet pump can be fed by opening the second metering valve while the first metering valve of the first jet pump remains closed. Moreover, the two jet pumps connected in parallel can be operated jointly. The efficiency of the device and/or the fuel cell system can be improved and an efficient supply of hydrogen to the fuel cell can be ensured over at least almost all operating conditions.

Accordingly, the proposed device is particularly suitable for performing the method according to the invention described below. With the aid of the device, the same advantages can therefore be achieved in order to improve the efficiency of the fuel cell system.

According to an advantageous embodiment in the proposed method for recirculating anode gas in an anode circuit of the fuel cell system, at least two parallel connected jet pumps are used, in which the second jet pump is permanently operated and the first jet pump can be switched on depending on the load, in particular by means of the first metering valve, in which case only the first jet pump comprises a check valve. In this way, the method can be operated such that the flow resistance of the flow lines can be reduced due to the absence of the second check valve in the region of the second jet pump. In this way, the efficiency of the fuel cell system can be improved by means of the method. In addition, both jet pumps can in principle also be used for the recirculation of anode gas. In this way, a consistently high recirculation performance can be achieved, both at high and low loads.

In a particularly advantageous embodiment of the method, it is proposed that only a second jet pump, which is designed for a low load, is operated at a low load. Doing so results in a load-adapted recirculation performance. At a high load, a high-load jet pump, which is the first jet pump, can be provided, which is then operated jointly with the low-load jet pump, which is the second jet pump.

In one particularly advantageous embodiment of the method, during operation of only the second jet pump, a reverse flow of anode gas through the respective first jet pump is prevented with the aid of at least a valve, in particular the check valve. If only one jet pump is operated, there is a risk of anode gas being drawn back via an inactive jet pump. When using the blocking element as the check valve, this can also be a passive or pressure-controlled valve, so that the implementation is also comparatively simple in this case. The at least one blocking element is preferably arranged in the region of the connection line.

The invention is not limited to the exemplary embodiments described herein and the aspects emphasized thereby. Rather, within the range specified by the claims, a large number of modifications are possible which lie within the abilities of a skilled person.

### BRIEF DESCRIPTION OF THE DRAWINGS

The invention will be described in greater detail hereinafter in reference to the drawings.

Preferred embodiments of the invention are described in greater detail hereinafter with reference to the accompanying drawings. Shown are:

FIG. 1 a schematic longitudinal section through a jet pump according to the invention

FIG. 2 a schematic illustration of a fuel cell arrangement according to the invention with a fuel cell and a device according to an exemplary embodiment

FIG. 3 a schematic illustration of a fuel cell arrangement according to the invention with a fuel cell and a device according to an exemplary embodiment

### DETAILED DESCRIPTION

The illustration according to FIG. 1 shows a schematic longitudinal section of a first jet pump 4 or a second jet pump 6.

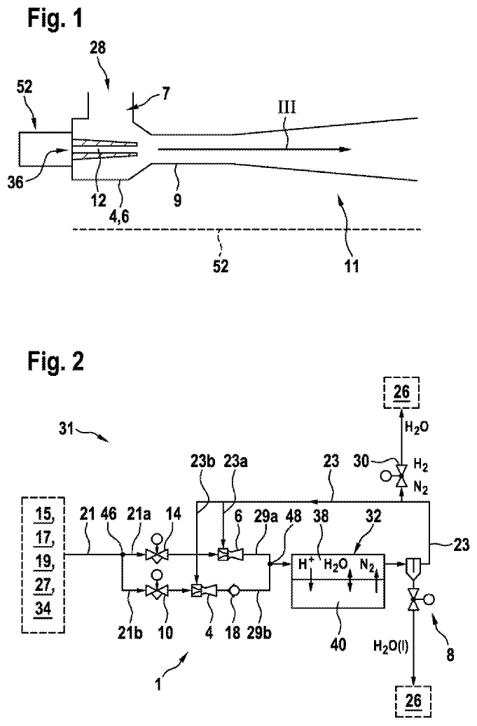

The jet pump 4, 6 comprises a first infeed 28, a second infeed 36, an intake region 7, a mixing tube 9, and a diffuser region 11. The anode gas flows at least partially through the jet pump 4, 6 in a flow direction III, whereby the flow direction III is parallel to a longitudinal axis 52 of the jet pump 4, 6. The majority of the flow-through areas of the jet pump 4, 6 are at least approximately tubular and serve to convey and/or direct the gaseous medium, which is in particular H₂ with portions of H₂O and N₂, in the jet pump 4, 6. In this case, the jet pump 4, 6 is supplied with a drive medium by means of the second inlet 36, which flows through a channel of a nozzle 12 into the intake region area 7 or the mixing tube 9. In addition, recirculated material is supplied to the jet pump 4, 6 through the first infeed 28, whereby the recirculated material is in particular the unused H2 from an anode region 38 (shown in FIG. 2) of a fuel cell 32, in particular a stack, whereby the recirculated material can also comprise water and nitrogen. The drive medium can come from a tank 34 and be at high pressures, in particular of more than 5 bar.

From the nozzle 12, the drive medium is discharged into the intake region 7 and/or the mixing tube 9. The hydrogen flowing through nozzle 12 and serving as a drive medium has a pressure difference and/or speed difference compared to the recirculation medium, which flows into the respective jet pump 4, 6 from the first infeed 28, whereby the drive medium in particular has a higher pressure of at least 5 bar. When what is referred to as a jet pump effect is adjusted, the recirculation medium is conveyed at a low pressure into the central flow area of the respective jet pump 4, 6. The drive medium flows through the nozzle 12 into the intake region 7 and/or the mixing tube 9 at the described pressure difference and a high speed, which can be in particular close to the speed of sound.

The nozzle 12 in this case comprises an internal recess in the form of a flow opening through which the gaseous medium can flow, in particular in the case of the first jet pump 4 from a first metering valve 10 and into the intake region 7 and/or the mixing tube 9. The drive medium meets the recirculation medium, which is already in the intake region 7 and/or the mixing tube 9. Due to the high speed and/or pressure difference between the drive medium and the recirculation medium, an internal friction and turbulence between the media is generated. A shear stress in the boundary layer thereby results between the fast drive medium and the substantially slower recirculation medium. This stress causes pulse transmission, whereby the recirculation medium is accelerated and entrained. The mixture occurs according to the principle of conservation of momentum. The recirculation medium is accelerated in the flow direction III, and a pressure drop is generated for the recirculation medium, whereby a suction effect occurs, so further recirculation medium is subsequently conveyed from the region of the first infeed 28.

This effect can be referred to as the jet pump effect. By controlling the metered addition of the drive medium by means of the first metering valve 10 and/or a first shut-off valve 15, a conveyance rate of the recirculation medium can be regulated and adjusted to the particular needs of an entire fuel cell system 31 (not shown in FIG. 1), depending on the operating state and operating requirements. In an exemplary operating state of the device 1 and/or the respective jet pump 4, 6, in which the first metering valve 10 is in the closed state, it can be prevented that the drive medium flows downstream from the second inlet 36 into the central flow area of the first jet pump 4 such that the drive medium cannot flow further in the flow direction III to the recirculation medium into the intake region 7 and/or the mixing tube 9, so the jet pump effect is halted. After passing through the mixing tube 9, the mixed medium to be conveyed, which consists in particular of the recirculation medium and the drive medium, flows in the flow direction III into the diffuser region 11, whereby a reduction of the flow rate can occur in the diffuser region 11. From there, the medium flows, e.g., further into the anode region 38 of the fuel cell 32.

As shown in FIG. 1, the respective metering valve 10, 14 can be located directly on the respective jet pump 4, 6, and in particular can form a common assembly therewith, whereby the respective metering valve 10, 14 can comprise a respective integrated drive nozzle 12a, b. The respective jet pump 4, 6 is supplied with fresh anode gas via the respective metering valve 10, 14 and/or the respective integrated drive nozzle 12a, b.

FIG. 2 shows a schematic illustration of a fuel cell system 31 according to the present invention with fuel cell 32 and device 1 according to a first exemplary embodiment. The device 1 is used to recirculate anode gas in an anode circuit of a fuel cell system 31, comprising at least two parallel connected jet pumps 4, 6, which can be operated individually or jointly depending on the load, whereby a drive medium, in particular from the tank 34 via the first shut-off valve 15 and/or a supply line 21, is at least indirectly supplied to the jet pumps 4, 6. In one exemplary embodiment, fresh anode gas, in particular a drive medium, flows from tank 34 via a tank line 27 to a second shut-off valve 17. The second shut-off valve 17 can be used to fluidically disconnect the tank 34 from the fuel cell system 31 and/or the fuel cell 32. The drive medium flows to a pressure control valve 19 from the second shut-off valve 17, which is in particular a pressure reducer 19, by means of which the pressure level of the anode gas coming from the tank 34 is reduced before it flows further into a medium-pressure line. The second shut-off valve 17 is typically used for safety reasons, whereby the second shut-off valve 17 is optionally used. In one possible exemplary embodiment of the fuel cell system 31, the pressure reduction can in this case be controlled down from a pressure level in the range of 700 bar, which prevails in the tank 34, to a pressure level in the range of 10 to 15 bar in the region of the medium-pressure line. The drive medium flows via the first shut-off valve 15 and the downstream supply line 21 from the medium-pressure line to the respective jet pump 4, 6. The supply line 21 branches from the first shut-off valve 15 coming in the region of a first node point 46 into a first supply line 21a and a second supply line 21b.

It is in this case shown that the device 1 and/or the respective jet pump 4, 6 are connected to the fuel cell 32 via a connection line 29, which comprises the anode region 38 and a cathode region 40. In addition, a return line 23 is provided that connects the anode region 38 of the fuel cell 32 at least indirectly to the respective first infeed 28, and thus in particular to the intake region 7, of the respective jet pump 4, 6. By means of the return line 23, the first gaseous medium not used up in the anode region 38 during operation of the fuel cell 32 can be returned to the first infeed 28. This first gaseous medium is in particular the recirculation medium described hereinabove. Also, in one exemplary embodiment a water separator 8 and/or a drain valve 30 can be located in the region of the return line 23. The unconsumed gaseous medium therefore flows from the fuel cell 32 into the water separator 8, in which the water is separated from the hydrogen, and in which the water is then discharged into an environment 26, e.g. by means of a valve 8. From there, the anode gas can flow back to the respective jet pump 4, 6 or to the drain valve 30 via the connection line 29. In the area of the drain valve 30, which is in particular a purge valve 30, water and/or hydrogen and/or nitrogen are output to the environment 26.

As shown in FIG. 2, the first jet pump 4 is fluidically connected at the inflow end or at the outflow end via at least one check valve 18 to the fuel cell 32, in particular the anode region 38, whereby the second jet pump 6 without such a check valve, in particular in the flow path, is fluidically connected at the inflow end or at the outflow end to the fuel cell 32, in particular the anode region 38. The second jet pump 6 therefore does not comprise a separate second check valve. It is particularly advantageous when the second jet pump 6 is designed for the smallest operating point of the fuel cell 32 that occurs and thus does not require any quantity regulation. The first jet pump 4, on the other hand, is designed for high-load operation and a quantity control of a drive medium, in particular in the context of a metered addition, is performed by the first metering valve 10. The second jet pump 6 is thus designed for low-load operation, and a quantity control of a drive medium, in particular in the context of a metered addition, is performed by the second metering valve 14. In contrast, the first jet pump 4 is designed for high-load operation, and a quantity control of a drive medium, in particular in the context of a metered addition, is performed by the first metering valve 10.

As shown in FIG. 2, the respective connection line 29a, b is located downstream of the respective jet pump 4, 6. The connection lines 29a, b converge in the region of a second node point 48 and/or are fluidically connected to each other and to a further region of the connection line 29. In this case, the respective jet pump 4, 6 is connected to the fuel cell 32 by means of the connection line 29. In the first embodiment shown in FIG. 2, the check valve 18 of the first jet pump 4 is located at the inflow end of the first inlet 28 in the region of the return line 23b or between the return line 23b and the first jet pump 4.

In the device 1 shown in FIG. 2, the second jet pump 6 can feature an at least approximately identical pressure build-up potential as the first jet pump 4, which is at least close to zero, in particular due to the geometric design of the second jet pump 6, even at a low conveying quantity. In the method disclosed for recirculating anode gas in which the at least two parallel connected jet pumps 4, 6 are used, in which the second jet pump 6 is permanently operated and the first jet pump 4 can be connected depending on the load. The connection can in this case be made by means of the first metering valve 10, whereby only the first jet pump 4 comprises a check valve 18. A variety of check valve 18 designs can be used, e.g., a spring-loaded or springless check valve 18 or a ball valve 18, plate valve, 18, or flap valve 18. In the method for operating the device 1, a reverse flow of anode gas through the first jet pump 4 is prevented in the second jet pump 6 with the aid of at least one check valve 18. In this way, the advantage can be achieved that the jet pumps 4, 6 can be connected in parallel in an efficient manner. In addition, the first jet pump 4 and the second jet pump 6 can therefore be efficiently connected in parallel, and an efficient supply of anode gas to the fuel cell 32 can be ensured at different operating states of the fuel cell system 31. In addition, a compact design of the device 1 and the connection lines 29a, 29b can be achieved with a fluidic connection thereof by means of the second node point 48.

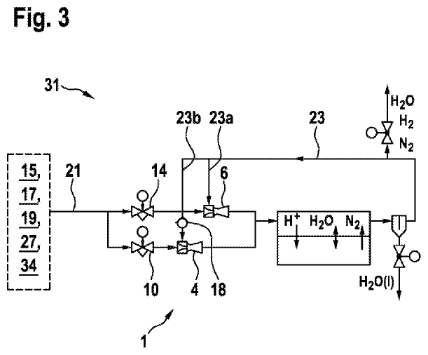

FIG. 3 is a schematic illustration of a fuel cell system 31 according to the invention with the fuel cell 32 and a device 1 according to an exemplary embodiment. The check valve 18 of the first jet pump 4 is in this case located at the inflow end in front of the first inlet 28 in the region of the return line 23b or between the return line 23b and the first jet pump 4, either at the outflow end in the region of the connection line 29b or between the connection line 29b and the first jet pump 4.

Although the present invention has been thoroughly described hereinabove with reference to the preferred exemplary embodiments, it is not limited thereto, and can rather be modified by many ways and means.

1. A device (1) for recirculating anode gas in an anode circuit of a fuel cell system (31), said device comprising at least two jet pumps (4, 6) connected in parallel, each of which can be operated individually or jointly depending on a load, wherein a drive medium is at least indirectly supplied to the jet pumps (4, 6) via an inlet line (21), wherein a first jet pump (4) on an inlet side comprises a first valve (10), and a second jet pump (6) on an inlet side comprises a second valve (14), wherein the jet pumps (4, 6) are at least indirectly fluidically connected to a fuel cell (32) via at least one connection line (29) and at least one return line (23), wherein the first jet pump (4) is fluidically connected at an inflow end or at an outflow end via at least one check valve (18) to the fuel cell (32), wherein the second jet pump (6) is fluidically connected to the fuel cell (32), on the inflow end and at the outflow end without a check valve.

2. The device (1) according to claim 1,
wherein the check valve (18) of the first jet pump (4) is located at the outflow end in a region of the at least one connection line (29b) or between the at least one connection line (29b) and the first jet pump (4) and/or at the inflow end via a first inlet (28) in a region of the at least one return line (23b) or between the at least one return line (23b) and the first jet pump (4).

3. The device (1) according to claim 1,
wherein the second jet pump (6) is configured for low-load operation and a quantity control of a drive medium, is performed by the second valve (14).

4. The device (1) according to claim 1,
wherein the first jet pump (4) is designed for high-load operation, and a quantity control of a drive medium, is performed by the first valve (10).

5. The device (1) according to claim 3,
wherein the second jet pump (6) also features at least an approximately identical pressure build-up potential as the first jet pump (4), which is at least nearly zero, even at a low conveying quantity.

6. The device (1) according to claim 1, wherein the supply line (21) branches from a first shut-off valve (15) coming in a region of a first node point (46) into a first supply line (21a) and a second supply line (21b).

7. The device (1) according to claim 1, wherein, in order to control the respective jet pump (4, 6), the respective first or second valve (10, 14) is further used by way of the respective first or second valve (10, 14) comprising an integrated drive nozzle (12a, b), via which valve fresh anode gas is supplied to the respective jet pump (10, 14).

8. A method for recirculating anode gas in an anode circuit of a fuel cell system (31), in which at least two parallel connected jet pumps (4, 6) are used, in which a second jet pump (6) is permanently operated, and a first jet pump (4) can be connected depending on a load by a first metering valve (10), wherein only the first jet pump (4) comprises a check valve (18).

9. The method according to claim 8, wherein only the second jet pump (6), which is configured for a low load, is operated at a low load.

10. The method according to claim 8,
wherein, during operation, only the second jet pump (6) prevents a reverse flow of anode gas through the first jet pump (4) with the check valve (18).

11. A fuel cell system having a device (1) according to claim 1, wherein the device (1) is arranged in an anode circuit of the fuel cell system (31).

12. The device (1) according to claim 4, wherein the second jet pump (6) also features at least an approximately identical pressure build-up potential as the first jet pump (4), which is at least nearly zero, even at a low conveying quantity.

13. The device (1) according to claim 1, wherein the drive medium is provided from a tank (34).

14. The device (1) according to claim 1, wherein the first valve (10) is a first metering valve (10), and wherein the second valve (14) is a second metering valve (14).

15. The device (1) according to claim 1, wherein the first jet pump (4) is fluidically connected to the fuel cell (32) at an anode region (38), and wherein the second jet pump (6) is fluidically connected to the fuel cell (32) at the anode region (38).

16. The device (1) according to claim 3, wherein the quantity control of a drive medium includes metered addition performed by the second valve (14).

17. The device (1) according to claim 4, wherein the quantity control of a drive medium includes metered addition performed by the first valve (10).
